(19) United States
(12) Patent Application Publication
(10) Pub. No.: US 2008/0068849 A1
(43) Pub. Date: Mar. 20, 2008

(54) ATV worklight

(75) Inventors: Scott G. Ostroski, Roseau, MN (US); Scott D. Taylor, Roseau, MN (US)

Correspondence Address: BAKER & DANIELS LLP, 300 NORTH MERIDIAN STREET, SUITE 2700, INDIANAPOLIS, IN, 46204, US

(73) Assignee: Polaris Industries Inc., Medina, MN (US)

(21) Appl. No.: 10/975,696

(22) Filed: Oct. 28, 2004

(51) Int. Cl. B62J 6/04

(52) U.S. Cl. 362/473; 362/540

(57) ABSTRACT

Devices for providing working light for off-road vehicles and methods using those devices. The present invention includes worklights on off-road vehicles such as all terrain vehicles, off-road utility vehicles, and snowmobiles. Such worklights can be located on the rear or side of the off-road vehicles and may be controllable from switches on the off-road vehicles. Such lights are preferably white in projected color and sufficiently bright to illuminate the ground to the side or rear of the off-road vehicle. Worklights are not operable by the backing up of the vehicle, and preferably operate independently of any turn signal controls, running light controls, break light controls, and backing up light controls, if any.

The present invention is related to off-road vehicles having worklights. More specifically, the present invention is related to off-road vehicles, which are not licensable for street use, such as all-terrain vehicles, off-road utility vehicles, and snowmobiles having worklights.

### BACKGROUND

Off-road vehicles have become increasingly popular in recent years. All-terrain vehicles (ATVs) include three-wheel all-terrain vehicles having straddle type seats and four-wheel all-terrain vehicles having straddle type seats. For the purposes of the present patent application, and any patent application claiming priority thereto, and only for those purposes, the phrase “off-road vehicles” is herein defined to include vehicles that are not commonly licensable for street use, including the all-terrain vehicles previously described, together with off-road utility vehicles and snowmobiles. Off-road utility vehicles include four-wheel utility vehicles having, a straddle type seat, a bench-type seat or bucket-type seats. One such utility vehicle is sold under the name RANGER (Polaris Industries, Minneapolis, Minn.).

The off-road vehicles have proven their value in both recreation and utility. In recreation, snowmobiles provide a fun and exciting mode of transportation across snow-covered and ice-covered terrain that would normally be almost impassable by most other motorized vehicles. Snowmobiles have also shown their utility in providing access for farmers, ranchers, and rescue personnel to snow-covered regions well away from plowed roads. All-terrain vehicles have been used for some time on construction sites, allowing transport of workers and material over rough ground under construction. All-terrain vehicles have also provided access to distant, hilly, rough terrain for purposes of hunting, fishing, scouting, general exploration, and military use, well away from roads. More recently, utility vehicles have shown their value as off-road vehicles providing added seating and added capacity for hauling gear or construction materials.

Off-road vehicles, being off-road vehicles, often face environments that are different than those faced by automobiles and trucks. Specifically, off-road vehicles may find themselves far from the nearest road, far from the nearest streetlight, and in sometimes primitive and unexpectedly rough or otherwise unknown terrain. Examples include all-terrain vehicles stopped in the brush, looking for dropped gear or fallen game, or stopped to read a map. Another example includes a snowmobile, stopped to check a fence line or ice fishing hole. In still another example, a utility vehicle may be stopped in the woods to transport or field dress a deer, to haul wood, or to tow another, inoperable, off-road vehicle to the hitch of the first vehicle. In these examples, often occurring at night, current lighting systems on off-road vehicles may be inadequate. This may be because such lighting systems were initially copied from those of cars, trucks, or motorcycles. Such vehicles have limited need for providing lighting, in the brush, at night. While flashlights provide light, they may require holding, and they are often not thought of until they are needed, and therefore not available. In off-road vehicles, storage space is often at a premium, and flashlights, while nice to have along, are but one of many things that are nice to have along, and are therefore often not brought along. Many situations that are faced in the dark in an off-road environment are unexpected and unplanned for, where the operator did not anticipate the need for a flashlight. One example is attempting to tow an inoperable second off-road vehicle out of the woods at night, where the breakdown of the inoperable vehicle was not foreseen.

What would be advantageous is an improved lighting system for off-road vehicles. What would be desirable is a lighting system providing working light in directions other than the headlight for off-road vehicles, to provide lighting for the unique needs of off-road vehicles.

### SUMMARY

The present invention provides off-road vehicles including means for propelling the vehicle over open ground, an engine coupled to the propelling means, a seat coupled to the vehicle, means for steering the vehicle, a rear-facing exterior surface and a side-facing exterior surface. The off-road vehicle can include a light secured to either rear or side-facing exterior surface and disposed to project white light at least partially rearwardly and/or sidewardly. The light is not configured to operate only as a backup light. In some embodiments, the light is configured to operate as a backup light, but can also be turned on independently of the back up logic.

In some vehicles, the light is mounted on the vehicle's side facing exterior surface, while in other vehicles, the light is mounted on the rear-facing exterior surface. In still other vehicles, the light is secured to the vehicle frame and is disposed to project light rearwardly and/or sidewardly. In some vehicles, the light is removably coupled to the vehicle such that the light can be removed from the vehicle and replaced on the vehicle without tools, and remain operable after removal. Some vehicles have a light that is swivel-mounted to the vehicle such that the light can be projected at varying angles from the vehicle. The light may be removably coupled to the vehicle in some embodiments, and also electrically coupled with an electrical cord, such that the light can be removed from the vehicle without tools, remain operable after removal, and be powered from the vehicle after removal through the electrical cord. In some vehicles, the electrical cord is coupled to the vehicle with a cigarette lighter type adapter that is coupled to a socket on the side or rear of the vehicle.

Some off-road vehicle lights include batteries that are removable with the light to power the light after removal. Some of the lights, according to the present invention, consume at least about 12 watts or at least about 20 watts, depending on the embodiment. Some lights have a timer that shuts off the light after a period of time. This timer may be located in the light or elsewhere in the vehicle and be electrically coupled to the light.

Some lights are electrically coupled to, and controlled by, a control switch located on the vehicle. Some control switches are located on the steering means. The control may be located on or near the steering wheel, a steering column, handle bars, instrument panel, or headlight pod, depending on the embodiment.

In some vehicles, the light is controlled in part or in whole by the transmission of the vehicle. Specifically, in one example, the light is activated when the transmission is placed in neutral. In our embodiments, a transmission setting together with another control switch is required to turn the light on. In still another embodiment, a transmission setting together with a low ambient light level is required to activate the light. Some light switch controls are mounted near the light, on the side or rear of the vehicle. In some lights, the light control switch is mounted on the light itself, and may be removable with the light from the vehicle.

Some lights are mounted in a common assembly with a conventional light. Worklights according to the present invention may be mounted in a common assembly with a rear turn signal light, a rear brake light, or a rear running light. Such shared assembly may include a separate reflector for the working light and the other light. In one embodiment, the working light and the other light in the assembly have differently colored lenses or bezels that may be disposed in substantially the same plane with each other. In such examples, the running light may have a red lens over the light bulb and the working light may have a white lens over the working light light bulb.

In some lights, the light is powered by rechargeable batteries removable from the vehicle with the light, such that the light is operable and powered by the batteries after removal from the vehicle. Such lights may include recharging circuitry for recharging the batteries from the vehicle. Some vehicles may include a remotely controlled worklight, which may assist in locating the off-road vehicle in dense underbrush at night.

The present invention also includes methods for providing light neat an off-road vehicle. The methods can include activating a switch on an off-road vehicle that provides power to a worklight secured to the vehicle and oriented rearwardly or sidewardly from the rear or side of the off-road vehicle. Such methods may include activating the switch from a steering wheel, a steering column, an instrument panel, a headlight pod, or handlebars, depending on the embodiment. The method may further include tilting the worklight while the light is on the vehicle, to aim the light in a desired direction. Some methods also include removing the light from the vehicle without using tools, to provide a worklight after the light has been removed from the vehicle.

### DRAWINGS

FIG. 1 is a rear view of one off-road vehicle, a four-wheel ATV, having combination rear work lights and running lights.

FIG. 2 is a detail view of the combination work light and running light of FIG. 1.

FIG. 3 is an exploded view of the combination work light and running light of FIG. 2.

FIG. 4 is a rear view of an off-road vehicle, a four-wheel all-terrain vehicle, having conventional rear lights and an additional rear working light, controlled from the rocker switch on the headlight pod.

FIG. 5 is a fragmentary, rear view of another all-terrain vehicle having the rear working light of FIG. 4, but having the control on a handlebar.

FIG. 6 is a perspective view of another off-road vehicle, a four-wheel all-terrain vehicle having a side-mounted working light.

FIG. 7 is a detail view of the side-mounted working light of FIG. 6, shown as removable from the off-road vehicle and powered by an electrical cord coupled to the vehicle.

FIG. 8 is a detail view of another side-mounted working light, also removable from the vehicle and having internal batteries so as to be powered away from the vehicle.

FIG. 9 is a detail view of yet another side-mounted working light, being adapted to swivel in the vertical and horizontal directions to aim the light.

FIG. 10 is a perspective view of still another off-road vehicle, a three-wheel all-terrain vehicle including a side-mounted working light.

FIG. 11 is a perspective view of another off-road vehicle, a four-wheel utility vehicle, having one working light side-mounted on the rear bed and another working light side-mounted on the body.

FIG. 12 is a rear view of the off-road vehicle of FIG. 11, including both the combination working light and running light of FIG. 1 as well as another rear-mounted working light on the bed rear.

FIG. 13 is a perspective view of another off-road vehicle, a snowmobile, including a side-mounted working light.

FIG. 14 is a fragmentary, rear view of the snowmobile of FIG. 13, having a rear mounted, combination running light and working light.

### DESCRIPTION OF VARIOUS EMBODIMENTS

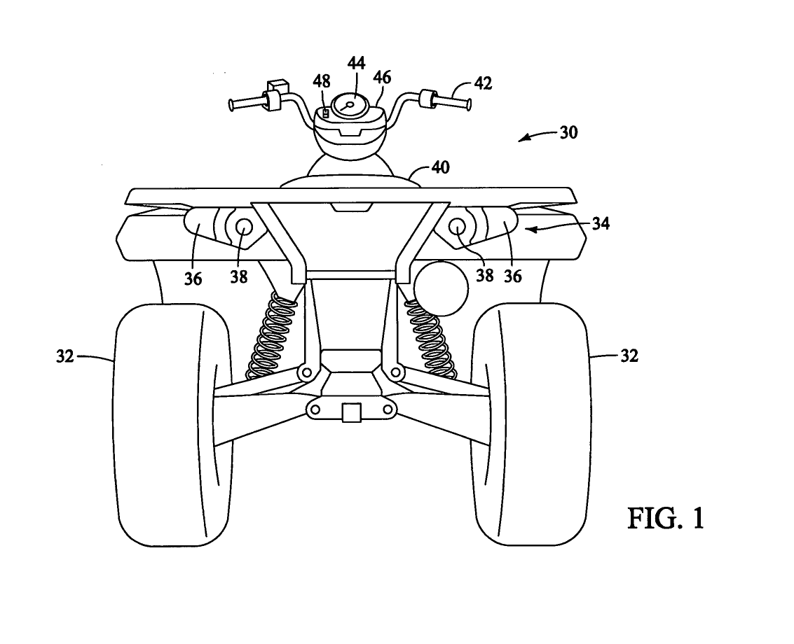

FIG. 1 illustrates an off-road vehicle having one embodiment of the present invention. The off-road vehicle illustrated is a four-wheel all-terrain vehicle (AVT) 30. ATV 30 includes generally four wheels 32, a straddle-type seat 40, a speedometer 44, a headlight pod 46, handlebars for steering 42 and a rocker switch 48 for controlling a working light described later. ATV 30 includes a combination light 34, which includes a running light portion 38 and a working light portion 36. In the embodiment illustrated, ATV 30 has two combination lights 34, one on each side of the seat 40.

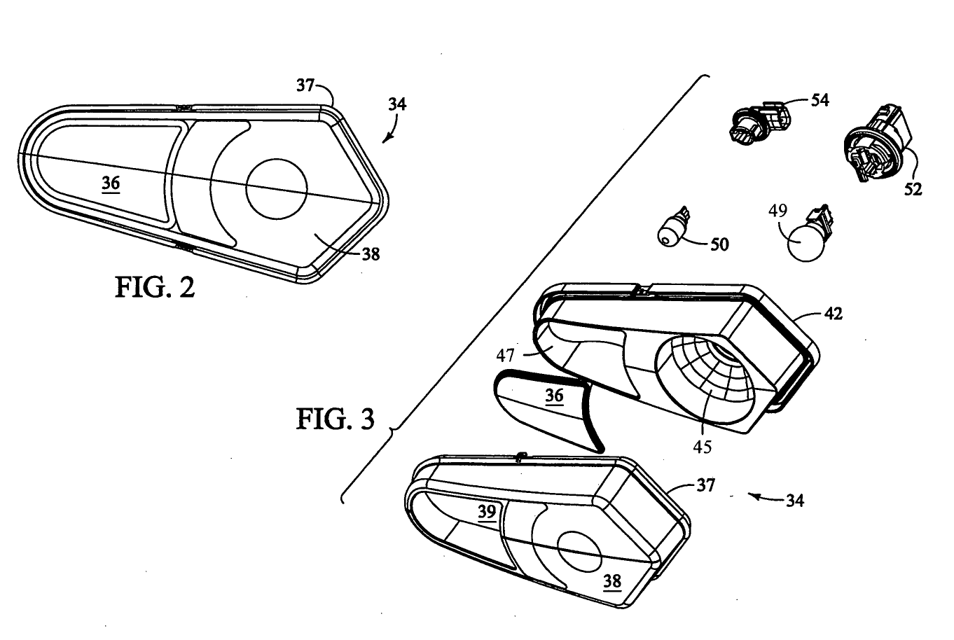

FIG. 2 further illustrates combination light 34 of FIG. 1. Combination light 34 includes a lens or bezel structure 37 including a running light/brake light region 38, and a working light region 36. Running light portion 38 may be red in color, while working light portion 36 is preferably white in color. Specifically, working light portion 36 should preferably project a white light as the working light color. Running light portion 38 and working light portion 36 may lie substantially within the same plane and be contained within the same structure in some embodiments.

FIG. 3 shows an exploded view of combination light 34, including running light portion 38 and working light portion 36, previously described. Lens structure 37, in the embodiment illustrated, includes an aperture 39 for receiving working light portion 36. Running light portion 38 can thus be formed of a red, translucent material, leaving aperture 39 free and open to receive a white lens 36 for the working light. Lens structure 37 can be adapted to fit over a light base structure 42 having generally a running light reflector bowl 44 and aperture 46 configured to seat working light lens portion 36. A running light bulb socket 52 is shown, for receiving and powering a running light bulb 48. A working light socket fixture 54 is also illustrated for receiving and powering a working light bulb 50. In some embodiments, working light bulb 50 is at least about 12 watts, depending on the embodiment.

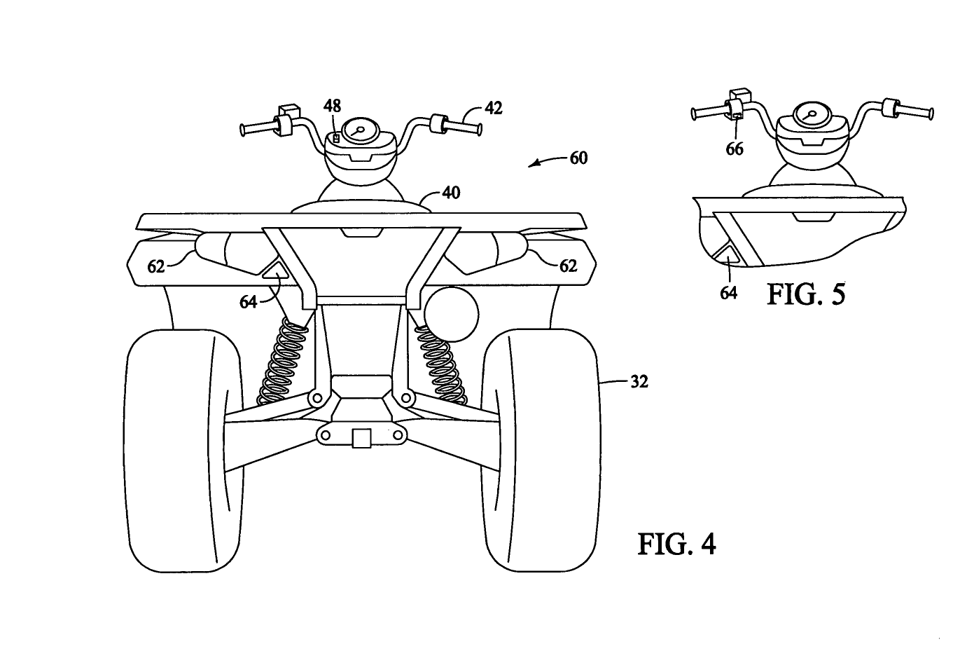

FIG. 4 illustrates another off-road vehicle, another four wheel ATV 60 being similar in many respects to ATV 30 of FIG. 1, having handlebars 42, straddle-type seat 40, wheels 32 and working light control switch 48. ATV 60, however, has a conventional rear light 62 and an additional working light 64, which is shown as rear-mounted and rear-projecting.

FIG. 5 illustrates a variation of ATV 60 of FIG. 4 having again the independent, discreet working light 64, but with the working light being controlled by a handlebar-mounted control switch 66.

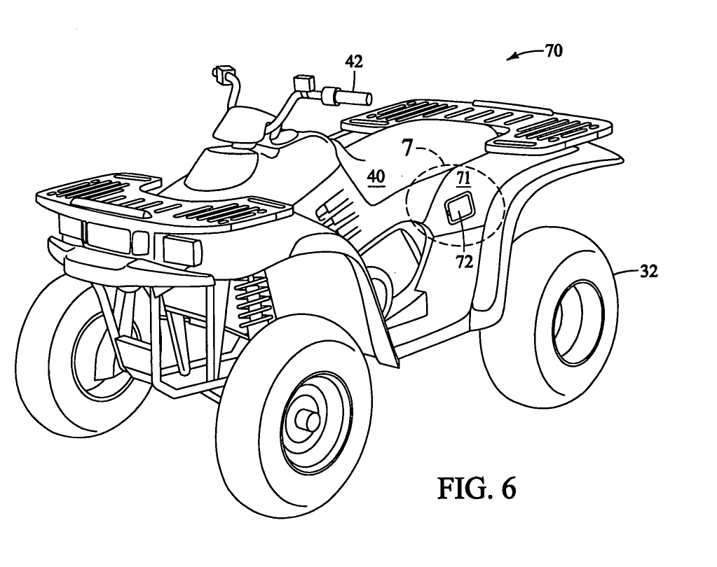

FIG. 6 illustrates yet another off-road vehicle, another four-wheel ATV 70 including handlebars 42, wheels 32 and straddle-type seat 40. ATV 70 includes a side body region 71 that carries a side-mounted working light 72.

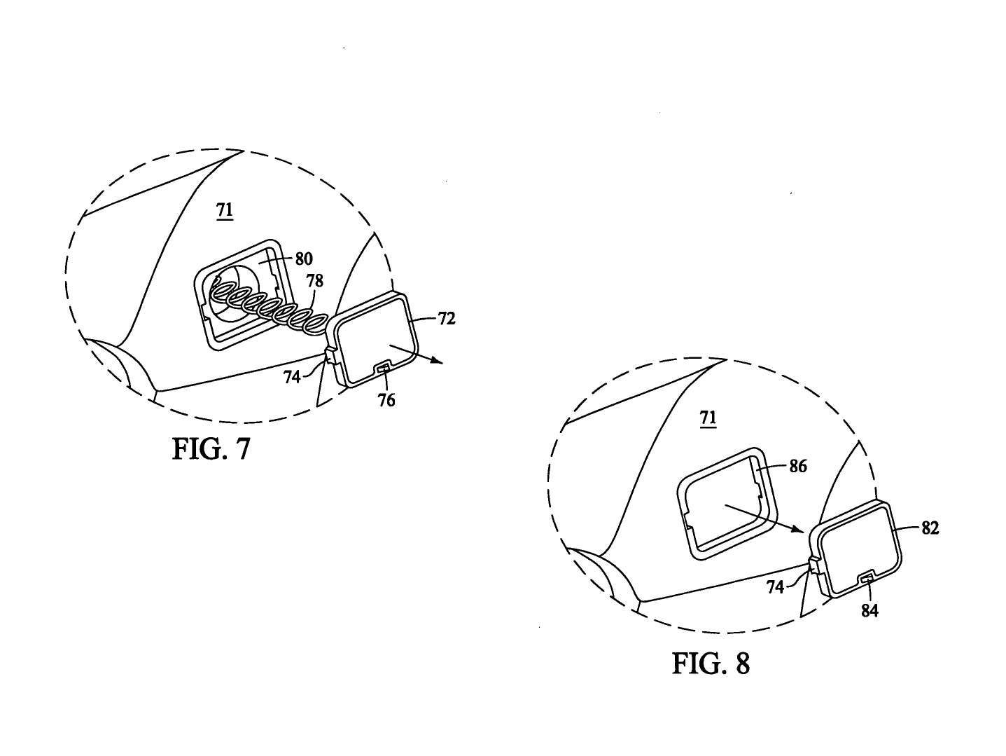

FIG. 7 illustrates a detail view of ATV side regions 71 of FIG. 6. ATV side region 71 includes a working light 72 removable from a mounting socket 80 and powered through a coiled extension cord 78. Working light 72, in this embodiment, includes mounting clips 74 and a local on-off switch 76. In some embodiments, coiled electrical cord 78 may be coupled to receiving socket 80 using a cigarette lighter-type adapter, to allow other devices to be powered from the same receiving socket.

FIG. 8 shows another embodiment of a work light mounted to ATV side region 71. In this embodiment, a work light 82 again has a local on-off switch 84 and is received within a receiving cavity 86. In this embodiment, work light 82 is locally and independently powered by batteries, allowing work light 82 to be removed from the ATV and used independently. Work light 82 includes rechargeable batteries, which are charged from the ATV itself. Mounting clips 74 can allow the working light to be removed from the ATV without requiring the use of tools. Likewise, working light 82 can be replaced without the use of tools.

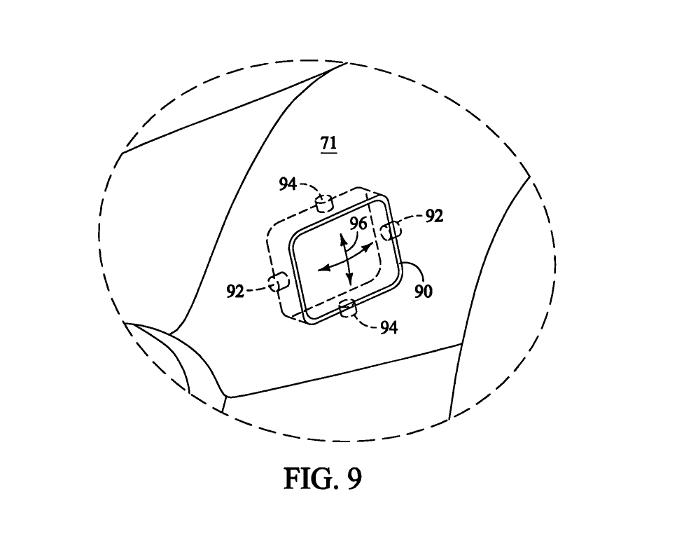

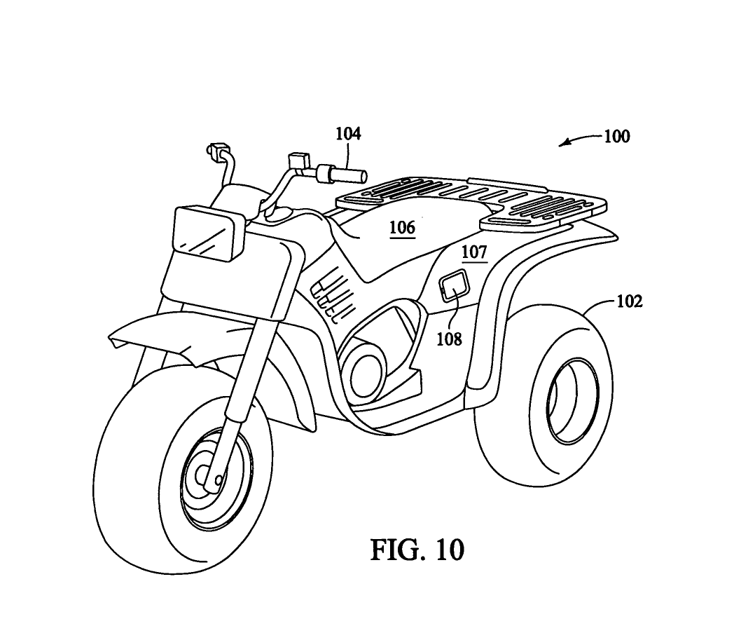

FIG. 9 illustrates another ATV side region 71 having again a work light 90 which can be swiveled or aimed as indicated by arrows 96. Work light 90, in the embodiment illustrated, includes vertical pivots 94 for horizontal movement and horizontally-oriented pivots 92 for vertical movement. The embodiment illustrated in FIG. 9 is highly diagrammatic, with swivel-mounted devices generally well-known and not requiring exhaustive explanation here.

FIG. 10 illustrates still another off-road vehicle, a three-wheel ATV 100. ATV 100 includes generally three-wheels 102, a straddle-type seat 106, and handlebars 104. ATV 100 includes a side-facing region 107 having a work light 108 mounted therein. Work light 108 can be similar to any of the work lights described in the present invention.

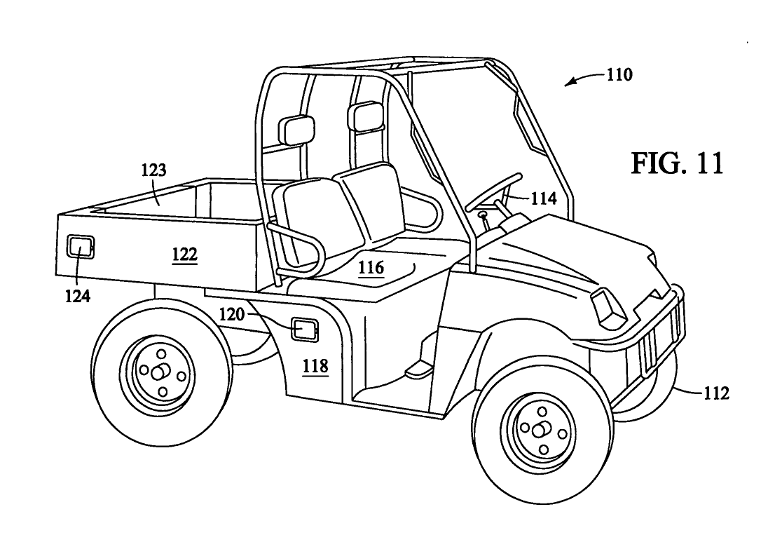

FIG. 11 illustrates another off-road vehicle, a four-wheel, off-road utility vehicle 110. Utility vehicle 110 includes generally four wheels 112, bench or bucket-type seats 116, a steering wheel 114, a bed 123, and a side-facing region of the body 118. Body side-facing region 118 includes a work light 120 received therein, which can be similar to the work lights previously discussed. Utility vehicle 110 may be seen to include a side-facing region 122 of bed 123. Side-facing bed region 122 includes a side-facing work light 124 exposed thereon or therein, depending upon the embodiment. Utility vehicle 110 thus illustrates two separate locations for work lights, 120 and 124. An actual utility vehicle may only have one such side-mounted work light in a preferred embodiment, but may have two side-mounted work lights in other embodiments.

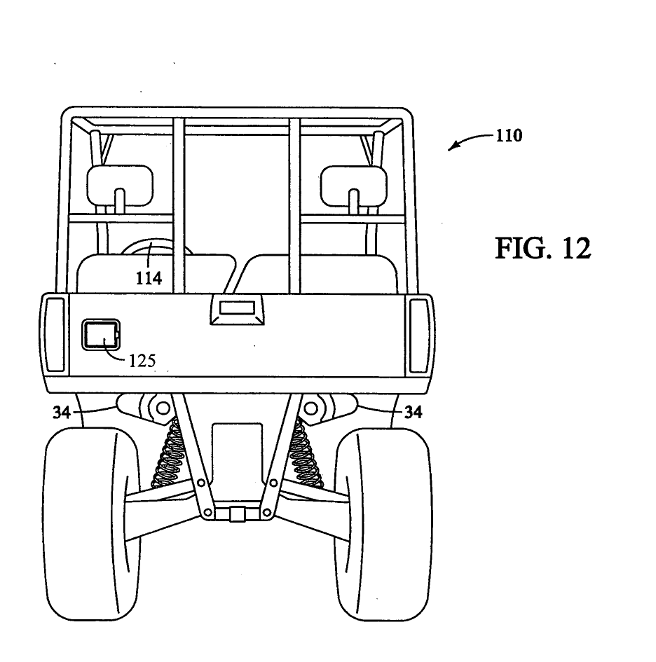

FIG. 12 illustrates utility vehicle 110 from a rear view illustrating two more locations for work lights, using the same utility vehicle for illustrative purposes. Utility vehicle 110 may be seen to include combination work lights and running lights 34 as previously discussed with respect to FIG. 1. Utility vehicle 110 also includes a rear-facing bed region that has yet another rear-facing work light 116 disposed therein. Rear-facing work light 116 may be similar to any of the work lights previously described.

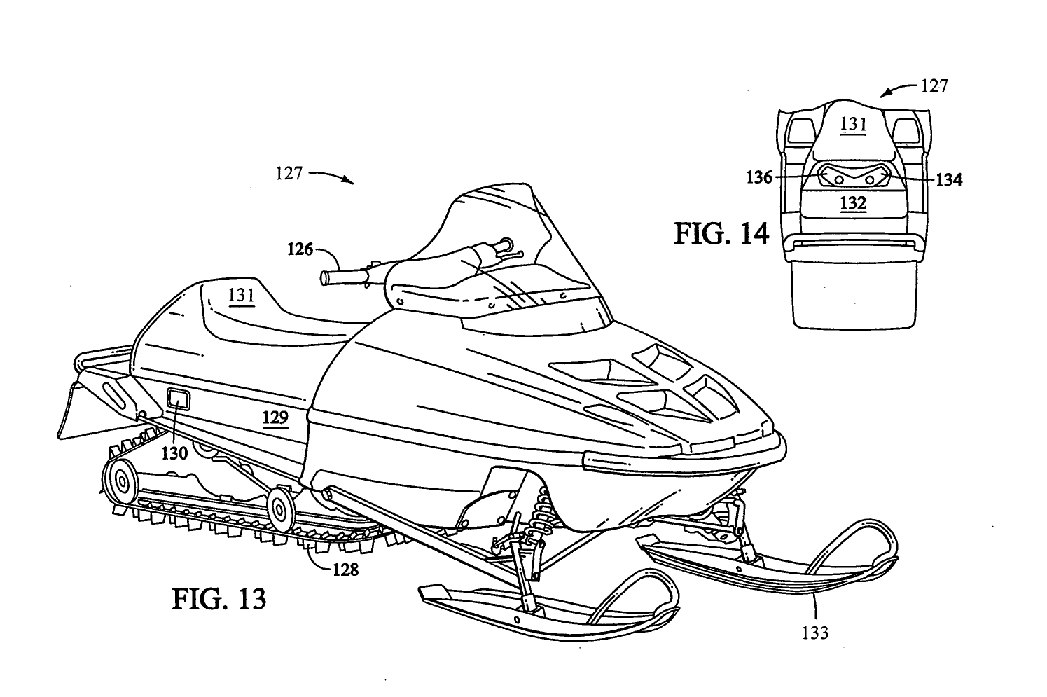

FIG. 13 illustrates still another off-road vehicle, a snowmobile 120. Snowmobile 120 includes generally a straddle-type seat 124, handlebars 126, skis 122, and a track 128. Snowmobile 120 also includes a side-facing region 129 having a side-facing work light 130 therein.

FIG. 14 illustrates snowmobile 120 from the rear, showing a rear-facing region 132 behind straddle-type seat 124. Rear-facing region may be seen to have a smaller version composite set of work lights including a right composite work light and running light combination 134 and a left work light and running light combination 136. In some embodiments, there will be a right running light and a left running light and a central, single rear-facing work light, which may all be formed as part of a single structure.

As previously illustrated, a work light may be controlled from the handlebars, an instrument panel, a headlight pod, a steering wheel, or a steering column. Some lights have local controls, mounted on lights or near the lights themselves. Some lights include timers coupled to the lights to allow the lights to time out after a set interval to avoid draining the battery. Some lights include LEDs in order to extend the battery life supplying the lights.

As used herein, the term “off-road vehicle” specifically includes three-wheel all-terrain vehicles, four-wheel all-terrain vehicles, snowmobiles, and four-wheel utility vehicles. As used herein, the term off-road vehicle is limited to vehicles that are not commonly licensable for on-street use.

The present invention includes methods for providing light near an off-road vehicle, including turning the light on and off from controls not operably coupled to the brake light or running light controls. Some embodiments allow the working light to be controlled from switches on or near the handlebars, the steering wheel, or headlight pod or instrument panel. The present invention provides a way for providing working light near an ATV without having to remember to bring a separate flashlight, as the need for the working light may not always be planned. The light provided may also be help in place without tying up a person's hands.

Uses for the off-road vehicle working lights may include providing rear-facing light for attaching or detaching devices being towed behind the off-road vehicle. Working lights may also be used to field dress game and fix or maintain other equipment in the field. The working lights may be used to effect mechanical repairs on other ATVs or to provide light during hunting, fishing or camping activities.

Thus, embodiments of the ATV work light are disclosed. One skilled in the art will appreciate that the present invention can be practiced with embodiments other than those disclosed. The disclosed embodiments are presented for purposes of illustration and not limitation, and the present invention is limited only by the claims that follow.

1. An off-road vehicle selected from the group consisting of 3 or more wheeled ATVs, off-road utility vehicles, and snowmobiles, comprising:
means for propelling the vehicle over open ground;
an engine coupled to the propelling means;
a seat supported by the propelling means;
means for steering the vehicle positioned forward of the seat;
a light secured to the off-road vehicle and disposed to project substantially white light substantially rearward and/or substantially sideward, wherein the light is not configured to operate only as a back-up light;
a substantially side facing exterior surface supported by the propelling means;
a substantially rear facing exterior surface supported by the propelling means; and
wherein at least one of the substantially side facing exterior surface and the substantially rear facing exterior surface includes a receiving cavity, and the light is supported within the receiving cavity.

2. (canceled)

3. (canceled)

4. The vehicle of claim 1, in which the light is removably coupled to the vehicle such that the light can be removed and replaced from the vehicle without tools and remain operable after removal.

5. The vehicle of claim 1, in which the light is swivel mounted to the vehicle such that light can be projected at varying angles from the vehicle.

6. The vehicle of claim 1, in which the light is removably coupled to the vehicle and electrically coupled with an electrical cord such that the light can be removed from the vehicle without tools, remain operable after removal, and be powered through the electrical cord from the vehicle after removal.

7. The vehicle of claim 1, in which the light includes batteries that are removable with the light to power to light after removal.

8. The vehicle of claim 1, in which the light consumes at least about 12 watts.

9. The vehicle of claim 1, in which the light consumes at least about 20 watts.

10. The vehicle of claim 1, in which the light is electrically coupled to, and controlled by, a control located on the steering means.

11. The vehicle of claim 10, in which the steering means includes handle bars, and in which the light is electrically coupled to and controlled by a control located on the handlebars.

12. The vehicle of claim 1, in which the steering means includes a steering wheel, and steering column, and in which the light is electrically coupled to and controlled by a control located on the steering wheel or steering column.

13. The vehicle of claim 1, further comprising an instrument control panel, in which the light is electrically coupled to and controlled by a control located on the instrument control panel.

14. The vehicle of claim 1, further comprising a headlight pod, in which the light is electrically coupled and controlled by a control located on the headlight pod.

15. The vehicle of claim 1, in which the vehicle includes a rear hitch and in which the light has a beam preferentially toward the hitch.

16. The vehicle of claim 1, in which the light is mounted in a common assembly with a rear turn signal light.

17. The vehicle of claim 1, in which the light is mounted in a common assembly with a rear brake light.

18. The vehicle of claim 1, in which the light is mounted in a common assembly with a rear running light.

19. The vehicle of claim 1, in which the light is mounted in a common assembly with another rear facing light that is not a work light.

20. The vehicle of claim 19, in which the work light and the other light each have a lens that is differently colored from each other.

21. The vehicle of claim 19, in which the work light and the other light each have a lens that is differently colored from each other and disposed in substantially the same plane as each other or substantially contiguous with each other.

22. The vehicle of claim 1, in which the light is powered by rechargeable batteries removable from the vehicle with the light, such that the light is operable and powered by the batteries after removal from the vehicle.

23. The vehicle of claim 22, in which the light includes recharging circuitry for recharging the batteries from the vehicle.

24. The vehicle of claim 1, in which the light is controlled by an auto timer shut-off.

25. The vehicle of claim 1, in which the light is controlled at least in part by the setting of a transmission.

26. The vehicle of claim 1, in which the light is controlled by a combination of the setting of a transmission and a control switch.

27. The vehicle of claim 1, in which the light is controlled by a rear or side mounted control switch.

28. The vehicle of claim 1, in which the light is controlled by a remote, wireless control switch.

29. The vehicle of claim 6, in which the electrical cord is coupled to the vehicle through a side or rear mounted exterior cigarette lighter adapter.

30. A method for providing light near the side or rear of an off-road vehicle, the method comprising:
coupling a combination light including a running light portion and a working light portion to at least one of the rear and the side of the vehicle;
causing the running light portion to illuminate to provide light from at least one of the rear and the side of the vehicle;
operating a switch coupled to the vehicle; and
causing the working light portion to illuminate to provide light from at least one of the rear and the side of the vehicle in response to operating the switch and independently from the running light portion.

31. An off-road vehicle comprising:
a propelling member;
an engine operably coupled to the propelling member;
a seat supported by the propelling member;
a switch manually operable by a user supported on the seat;
a substantially side facing exterior surface supported by the propelling member;
a substantially rear facing exterior surface supported by the propelling member; and
a combination light supported by at least one of the substantially side facing exterior surface and the substantially rear facing exterior surface, the combination light including a running light portion and a working light portion, the working light portion operably coupled to the switch;
wherein operation of the switch by a user causes the working light portion to provide light from at least one of the substantially side facing exterior surface and the substantially rear facing exterior surface independently from illumination of the running light portion.

32. The vehicle of claim 31, further comprising a steering member positioned forward of the seat, wherein the switch is supported on the steering member.

33. The vehicle of claim 31, further comprising an instrument control panel positioned forward of the seat, wherein the switch is supported on the instrument control panel.

34. The vehicle of claim 31, further comprising a transmission operably coupled to the engine, wherein the running light is controlled at least in part by the setting of the transmission.
